(19) United States
(12) Patent Application Publication
(10) Pub. No.: US 2026/0229059 A1
(43) Pub. Date: Aug. 6, 2026

(54) CAMERA APPARATUS FOR PALM-SCAN RECOGNITION DEVICE

(71) Applicant: Tencent Technology (Shenzhen) Company Limited, Shenzhen (CN)

(72) Inventors: Shiyou SUN, Shenzhen (CN); Bincheng MO, Shenzhen (CN); Weibiao ZHOU, Shenzhen (CN); Changze XIAO, Shenzhen (CN); Kai XIA, Shenzhen (CN); Runzeng GUO, Shenzhen (CN); Jinkun HOU, Shenzhen (CN)

(73) Assignee: Tencent Technology (Shenzhen) Company Limited, Shenzhen (CN)

(21) Appl. No.: 19/574,018

(22) Filed: Mar. 20, 2026

Related U.S. Application Data
(63) Continuation of application No. PCT/CN2024/125598, filed on Oct. 17, 2024.

(30) Foreign Application Priority Data
Jan. 12, 2024 (CN) 202420092238.0

(51) Int. Cl. G06V 40/13; G02B 5/20; G02B 7/02; G02B 13/14; G06V 10/143; G06V 10/147; H04N 23/11; H04N 23/16; H04N 23/55

(52) U.S. Cl. CPC G06V 40/1312; G02B 5/208; G02B 7/021; G02B 13/14; G06V 10/143; G06V 10/147; H04N 23/11; H04N 23/16; H04N 23/55

(57) ABSTRACT

A camera apparatus for a palm-scan recognition device includes a first lens assembly and a first image sensor at an image side of the first lens assembly. The first lens assembly includes a lens barrel, a first set of lenses configured to converge light from an object side of the first lens assembly, and a second set of lenses configured to adjust a field of view and distortion of the first lens assembly observable at an image side of the first lens assembly. The first set of lenses includes one or more of a plastic lens or a spherical glass lens. The second set of lenses includes one or more of a freeform lens or a molded glass lens. The first set of lenses, the second set of lenses, and the first image sensor are inside the lens barrel.

### RELATED APPLICATIONS

The present application is a continuation of International Application No. PCT/CN2024/125598, filed on October 17, 2024, which claims priority to Chinese Patent Application No. 202420092238.0, filed on January 12, 2024, entitled "CAMERA MODULE FOR PALM-SCAN RECOGNITION DEVICE." The entire disclosures of the prior applications are hereby incorporated by reference.

### FIELD OF THE TECHNOLOGY

The present disclosure relates to the field of optical technologies, including a camera apparatus for a palm-scan recognition device and a palm-scan recognition device.

### BACKGROUND OF THE DISCLOSURE

A palm-scan recognition device can obtain a palm image of a user, and then identify a user by recognizing a palm feature.

In one or more applications, when using a palm-scan recognition device, the user places a hand above a camera apparatus of the palm-scan recognition device, and a palm may be placed from the camera apparatus by a distance of 5 cm to 15 cm, so that the palm-scan recognition device can obtain a clear palm image. If the palm is relatively close to the camera apparatus, the palm-scan recognition device may hardly obtain a complete palm image, causing the palm-scan recognition device to hardly identify the user.

### SUMMARY

According to a first aspect, the present disclosure provides a camera apparatus for a palm-scan recognition device. The palm-scan recognition device includes a first lens assembly and a first image sensor at an image side of the first lens assembly. The first lens assembly includes a lens barrel, a first set of lenses configured to converge light from an object side of the first lens assembly, and a second set of lenses configured to adjust a field of view and distortion of the first lens assembly observable at an image side of the first lens assembly. The first set of lenses includes one or more of a plastic lens or a spherical glass lens. The second set of lenses includes one or more of a freeform lens or a molded glass lens. The first set of lenses and the second set of lenses are inside the lens barrel.

According to a second aspect, the present disclosure provides a palm-scan recognition device. The palm-scan recognition device includes a first lens assembly and a first image sensor at an image side of the first lens assembly. The first lens assembly includes a lens barrel, a first set of lenses configured to converge light from an object side of the first lens assembly, and a second set of lenses configured to adjust a field of view and distortion of the first lens assembly observable at an image side of the first lens assembly. The first set of lenses includes one or more of a plastic lens or a spherical glass lens. The second set of lenses includes one or more of a freeform lens or a molded glass lens. The first set of lenses and the second set of lenses are inside the lens barrel.

According to a third aspect, the present disclosure provides a camera apparatus for a palm-scan recognition device. The camera apparatus for a palm-scan recognition device includes a lens assembly and an image sensor; the lens assembly includes a lens barrel, a first lens assembly, and a second lens assembly, the first set of lenses includes a plastic lens and/or a spherical glass lens, and the second set of lenses includes a freeform lens and/or a molded glass lens; and the first lens assembly, the second lens assembly, and the image sensor are fixed inside the lens barrel, and the image sensor is located on an image side of the first set of lenses and the second set of lenses.

According to a fourth aspect, the present disclosure provides a palm-scan recognition device. The palm-scan recognition device includes the camera apparatus for a palm-scan recognition device according to the first aspect.

### BRIEF DESCRIPTION OF THE DRAWINGS

FIG. 1 is a schematic structural diagram of a camera apparatus for a palm-scan recognition device according to an embodiment of the present disclosure.

FIG. 2 is a schematic structural diagram of a camera apparatus for a palm-scan recognition device according to an embodiment of the present disclosure.

FIG. 3 is a schematic structural diagram of a camera apparatus for a palm-scan recognition device according to an embodiment of the present disclosure.

FIG. 4 is a schematic structural diagram of a lens assembly according to an embodiment of the present disclosure.

FIG. 5 is a schematic structural diagram of a lens assembly according to an embodiment of the present disclosure.

FIG. 6 is a schematic structural diagram of a lens assembly according to an embodiment of the present disclosure.

FIG. 7 is a schematic structural diagram of a lens assembly according to an embodiment of the present disclosure.

FIG. 8 is a schematic structural diagram of a camera apparatus for a palm-scan recognition device according to an embodiment of the present disclosure.

FIG. 9 is a schematic diagram of arrangement of two lens modules according to an embodiment of the present disclosure.

FIG. 10 is a schematic diagram of arrangement of two lens modules according to an embodiment of the present disclosure.

FIG. 11 is a schematic diagram of arrangement of two lens modules according to an embodiment of the present disclosure.

FIG. 12 is a schematic diagram of arrangement of two lens modules according to an embodiment of the present disclosure.

FIG. 13 is a schematic structural diagram of a lens assembly according to an embodiment of the present disclosure.

### DESCRIPTION OF EMBODIMENTS

To describe objectives, technical solutions, and advantages of the present disclosure, implementations provided in the present disclosure are described below with reference to the accompanying drawings. Embodiments described should not be construed as a limitation on this disclosure. Other embodiments are within the scope of this disclosure.

Terms used in the implementations of the present disclosure are merely used to explain embodiments of the present disclosure, but are not intended to limit the present disclosure. Unless otherwise defined, technical terms or scientific terms used herein are to have general meanings understood by a person skilled in the art to which the present disclosure belongs. Terms "first", "second", "third", and the like used in the specification and claims of the present disclosure do not indicate any sequence, quantity, or importance, but are only used to distinguish different components. Similarly, terms "one", "a/an", or the like also do not indicate a quantity limitation, but indicate that at least one exists. Terms "include", "comprise", or the like mean that elements or objects before "include" or "comprise" include elements or objects listed after "include" or "comprise" and equivalent of the elements or objects listed after "include" or "comprise", and do not exclude another element or object. Terms "connection", "connected" or the like are not limited to a physical or mechanical connection, but may include an electrical connection, regardless of a direct connection or an indirect connection. "Up", "down", "left", "right", and the like are merely used to indicate a relative position relationship. After an absolute position of a described object changes, the relative position relationship may also correspondingly change.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Contactless palm-scan recognition and payment has proven to be a popular manner among users, which is more convenient than card swiping and QR code scanning, and more secure than another biometric manner, for example, face scanning. According to statistics on a large quantity of users, when a user uses a palm-scan recognition device, a distance between a palm and a lens assembly (or referred to as a camera module) of the palm-scan recognition device ranges from 3 cm to 5 cm in general.

However, in some applications, a field of view (FOV) of the camera apparatus for a palm-scan recognition device is small (e.g., insufficient to take a palm image at the distance of 3 cm to 5 cm). For example, when the user uses the palm-scan recognition device, the palm needs to be away from the lens assembly by 5 cm to 15 cm. If the palm is 3 cm away from the lens assembly, the palm-scan recognition device cannot obtain a complete palm image.

In some applications, lens assemblies of some palm-scan recognition devices are arranged in a sunken manner, to increase the distance between the palm and the lens assembly. However, this results in a larger overall size of the palm-scan recognition device and easier dust accumulation on an outside of the lens assembly. A groove formed after the lens assembly is sunken is more likely to accumulate dust. Therefore, on a premise that a position of the lens assembly is not changed, to enable the camera apparatus to photograph the palm at a short distance, a wide-angle lens assembly is to be used, that is, a field of view of the lens assembly is to be enlarged. However, a wide-angle lens according to other applications has large distortion and low clarity, and cannot meet a photographing requirement of palm recognition.

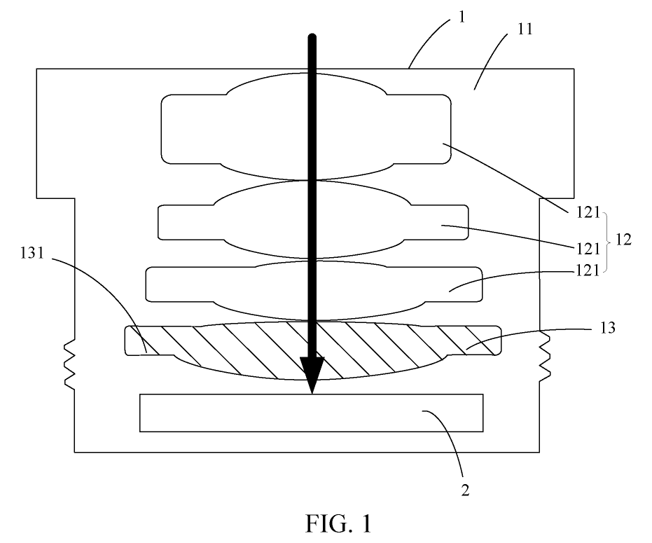

In view of the foregoing technical problem, an embodiment of the present disclosure provides a camera apparatus for a palm-scan recognition device. As shown in FIG. 1 to FIG. 3, the camera apparatus for a palm-scan recognition device includes a lens assembly 1 and an image sensor 2. The lens assembly 1 includes a lens barrel 11, a first set of lenses 12, and a second set of lenses 13. The first set of lenses 12 includes a plastic lens 121 and/or a spherical glass lens 122, and the second set of lenses 13 includes a freeform lens 131 and/or a molded glass lens 132. The first set of lenses 12, the second set of lenses 13, and the image sensor 2 are fixed inside the lens barrel 11, and the image sensor 2 is located on an image side of the first set of lenses 12 and the second set of lenses 13.

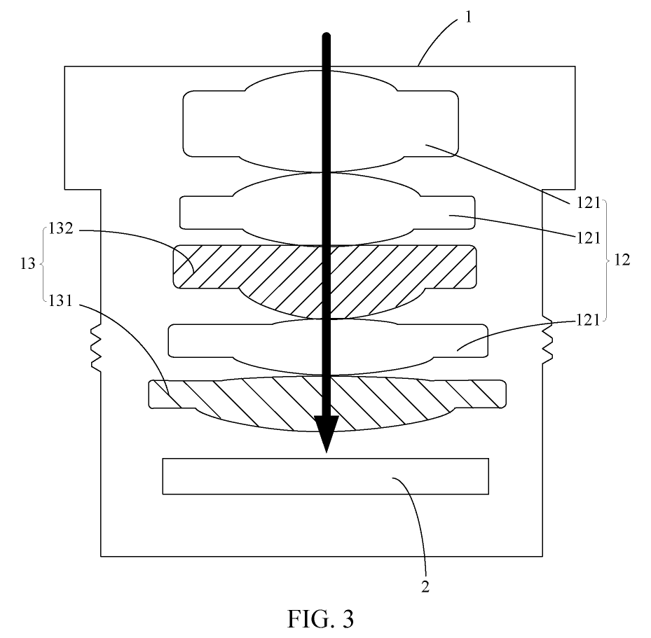

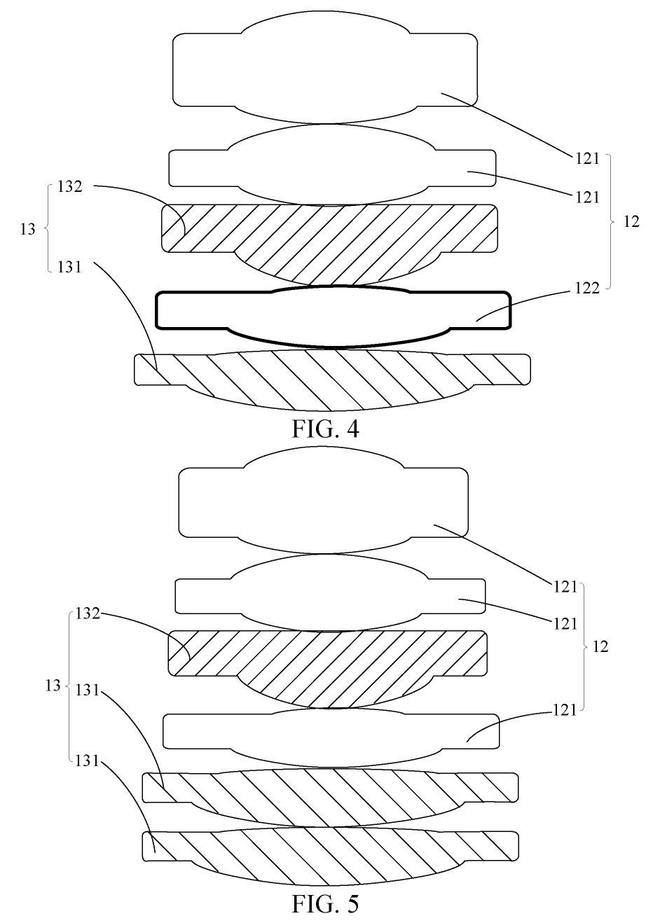

The first set of lenses 12 may include only the plastic lens 121, only the spherical glass lens 122, or both the plastic lens 121 and the spherical glass lens 122 (as shown in FIG. 4). Quantities and arrangements of the plastic lens 121 and the spherical glass lens 122 are not specifically limited in this embodiment of the present disclosure.

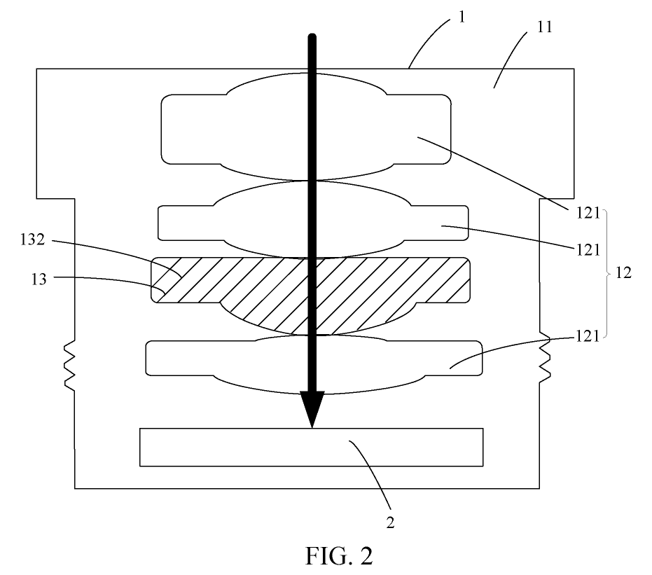

The second set of lenses 13 may include only a freeform lens 131 (as shown in FIG. 1), only a molded glass lens 132 (as shown in FIG. 2), or both the freeform lens 131 and the molded glass lens 132 (as shown in FIG. 3).

A plastic lens may also be referred to as a P (Plastic) lens, a spherical glass lens may also be referred to as a G (Glass) lens, a molded glass lens may also be referred to as a GM (Glass Molding) lens, and a freeform lens may also be referred to as a FreeForm lens.

The freeform lens 131 can enlarge a field of view of the lens assembly 1 and reduce distortion of the lens assembly 1, and can further improve relative illumination (RI) and a modulation transfer function (MTF) of the lens assembly 1, facilitating improvement on image quality.

The molded glass lens 132 has advantages such as high thermal stability, a high refractive index, low chromatic dispersion, a high transmittance, distortion elimination, and an expanded field of view, so that when the field of view of the lens assembly 1 is enlarged, the distortion of the lens assembly 1 can also be reduced. The molded glass lens 132 further helps the camera apparatus for a palm-scan recognition device to be used in more demanding conditions. In addition, a glass lens manufacturing technology in some examples requires complex operations, such as rough grinding, fine grinding, and polishing, taking a relatively long time. Production of the molded glass lens 132 only requires a pre-formed glass body, which can be directly molded into a finished product. Therefore, the molded glass lens 132 is quite suitable for mass production. Therefore, using the molded glass lens 132 in the camera apparatus for a palm-scan recognition device can improve production efficiency and facilitate mass production of the camera apparatus for a palm-scan recognition device.

The lens assembly 1 and the image sensor 2 in this embodiment of the present disclosure may also be used in a face-scan device.

According to the technical solution provided in this embodiment of the present disclosure, the lens assembly 1 in the camera apparatus for a palm-scan recognition device includes the first set of lenses 12 and the second set of lenses 13. The second set of lenses 13 is the freeform lens 131 or the molded glass lens 132, or the second set of lenses 13 includes the freeform lens 131 and the molded glass lens 132. Both the freeform lens 131 and the molded glass lens 132 can enlarge the field of view of the lens assembly 1. Therefore, when the lens assembly 1 is configured to photograph the palm, though the palm is relatively close to the lens assembly 1 or the palm is slightly offset, the lens assembly 1 can obtain the complete palm image. In addition, both the freeform lens 131 and the molded glass lens 132 can reduce the distortion of the lens assembly 1, so that the distortion of the lens assembly 1 is relatively small and clarity of the lens assembly 1 is improved, thereby avoiding distortion of an image obtained by the lens assembly 1, to facilitate acquisition of a clear palm image. In this way, when the palm is relatively close to the lens assembly 1, the camera apparatus for a palm-scan recognition device (that is, the image sensor 2) can obtain a complete and clear image, which is conducive to the camera apparatus for a palm-scan recognition device quickly and accurately identifying a user.

According to measurement, when the second set of lenses 13 includes the freeform lens 131 and the molded glass lens 132, a horizontal field of view of the lens assembly may reach 125° to 135°, and a vertical field of view of the lens assembly 1 may reach 115° to 125°.

In some examples, a degree of freedom of the freeform lens 131 ranges from 30 to 80. In the related technology, a maximum of a degree of freedom of the freeform lens is 40. The degree of freedom of the freeform lens 131 provided in this embodiment of the present disclosure is relatively high, significantly reducing the distortion of the lens assembly 1. In some examples, the degree of freedom of the freeform lens 131 is greater than 40. The degree of freedom of the freeform lens 131 refers to a quantity of adjustable variables or parameters in a curved surface equation configured to describe a curved surface shape of the freeform lens 131.

Through an experiment, a distortion rate of the lens assembly 1 in a horizontal direction is –13.3%, and a distortion rate of the lens assembly 1 in a vertical direction is –6.6%. Compared with a distortion rate of –35% in the horizontal direction and a distortion rate of –22% in the vertical direction of a lens assembly of a palm-scan recognition device, the distortion rate of the lens assembly 1 in this embodiment of the present disclosure is greatly reduced. In this way, a palm image obtained by the lens assembly 1 is clearer.

In some examples, as shown in FIG. 1 and FIG. 3, the freeform lens 131 is located on an image side of the first set of lenses 12. When the lens assembly 1 is assembled, lenses are placed from an object side of the lens assembly 1, and are gradually arranged toward an image side. The freeform lens 131 is placed on the image side of the first set of lenses 12, so that the freeform lens 131 can be mounted last. In this way, a collision between the freeform lens 131 and another lens can be avoided when the freeform lens 131 is mounted. In addition, the first set of lenses 12 can converge light. The freeform lens 131 is placed on the image side of the first set of lenses 12, so that as much light as possible converges on the freeform lens 131, which is conducive to the freeform lens 131 adjusting the light. The freeform lens 131 is a lens close to the image sensor 2 among a plurality of lenses of the second set of lenses 13. Because structural strength of the freeform lens 131 is poor, setting the freeform lens 131 as a lens closest to the image sensor 2 can protect the freeform lens 131. When the camera apparatus for a palm-scan recognition device is bumped, the freeform lens 131 is not easily damaged.

In some other examples, the freeform lens 131 may alternatively be located on an object side of the first set of lenses 12. Alternatively, when the first set of lenses 12 includes a plurality of lenses, the freeform lens 131 may be located inside the first set of lenses 12, that is, located between the plurality of lenses of the first set of lenses 12. This is not specifically limited in this embodiment of the present disclosure.

In some examples, as shown in FIG. 5 and FIG. 6, a quantity of the freeform lenses 131 may be one or more. The quantity of the freeform lenses 131 is not limited in this embodiment of the present disclosure. A plurality of freeform lenses 131 may be arranged sequentially and adjacently, or may be arranged alternately with the plurality of lenses of the first set of lenses 12.

In some examples, the molded glass lens 132 is an aspherical lens, and a degree of freedom of the molded glass lens 132 ranges from 10 to 30. The molded glass lens 132 can enlarge the field of view of the lens assembly 1 and reduce the distortion of the lens assembly 1. In the related technology, the degree of freedom of the molded glass lens 132 in the lens assembly is 16 generally. The degree of freedom of the molded glass lens 132 provided in this embodiment of the present disclosure is relatively high, which is conducive to further enlarging the field of view of the lens assembly 1 and reducing the distortion of the lens assembly 1. In some examples, the degree of freedom of the molded glass lens 132 is greater than 16. The degree of freedom of the molded glass lens 132 refers to a quantity of adjustable variables or parameters in a curved surface equation configured to describe a curved surface shape of the molded glass lens 132.

Ordinary spherical glass may cause defocusing due to chromatic aberration, while an aspherical lens compensates for this deficiency by correcting the chromatic aberration of a sphere. In addition, optical imaging requires two, three, or more spherical lenses to perform an imaging function, which can be achieved by using an aspherical lens instead. In this way, a quantity of lenses in the lens assembly 1 can be reduced.

In some examples, the molded glass lens 132 is located between the plurality of lenses included in the first set of lenses 12. This facilitates support for the lens barrel 11 provided by the molded glass lens 132.

In some examples, as shown in FIG. 3, the first set of lenses 12 includes three plastic lenses 121. The second set of lenses 13 includes the molded glass lens 132. Two plastic lenses 121 are provided on an object side of the molded glass lens 132, and one plastic lens 121 is provided on an image side of the molded glass lens 132. The two plastic lenses 121, the molded glass lens 132, the plastic lens 121, and the freeform lens 131 are sequentially arranged. Placing the molded glass lens 132 at a middle position of the plurality of lenses can provide good support for the lens barrel 11.

In some other examples, as shown in FIG. 4, the first set of lenses 12 may alternatively include two plastic lenses 121 and one spherical glass lens 122. Two plastic lenses 121 are provided on the object side of the molded glass lens 132, and one spherical glass lens 122 is provided on the image side of the molded glass lens 132. The two plastic lens 121, the molded glass lens 132, the spherical glass lens 122, the freeform lens 131, and the image sensor 2 are sequentially arranged in an axial direction of the lens barrel 11. A quantity and a type of the lenses of the first set of lenses 12 and relative positions of the first set of lenses 12 and the molded glass lens 132 are not specifically limited in this embodiment of the present disclosure.

In some examples, as shown in FIG. 3, the second set of lenses 13 includes the freeform lens 131 and the molded glass lens 132, and the freeform lens 131 is located on the image side of the molded glass lens 132.

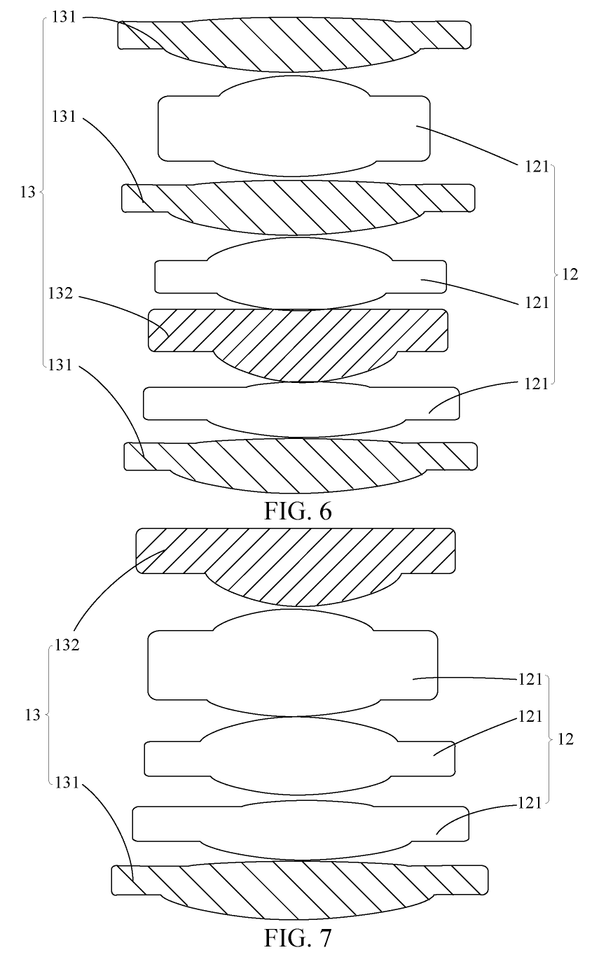

In some other examples, as shown in FIG. 6 and FIG. 7, the freeform lens 131 may be located on the object side of a molded glass lens 132.

As shown in FIG. 2 to FIG. 7, quantities and arrangements of the plastic lens 121, the spherical glass lens 122, the freeform lens 131, and the molded glass lens 132 are not specifically limited in this embodiment of the present disclosure. The plastic lens 121, the spherical glass lens 122, the freeform lens 131, and/or the molded glass lens 132 may be arranged in a free combination manner.

Because the field of view of the lens assembly 1 provided in this embodiment of the present disclosure is large, more light sources enter the lens assembly 1, so that the lens assembly 1 is more likely to generate glare. In other words, a light spot is likely to be generated on the palm image obtained by the lens assembly 1, and the light spot obscures some palm features, causing the palm-scan recognition device to hardly identify the user. To reduce the glare of the lens assembly 1, in some examples, an inner wall of the lens barrel 11 has an anti-glare coating, for example, ink. In this way, the anti-glare coating can absorb a part of light, preventing the palm image from being obscured by the light spot, which is conducive to the palm-scan recognition device identifying the user.

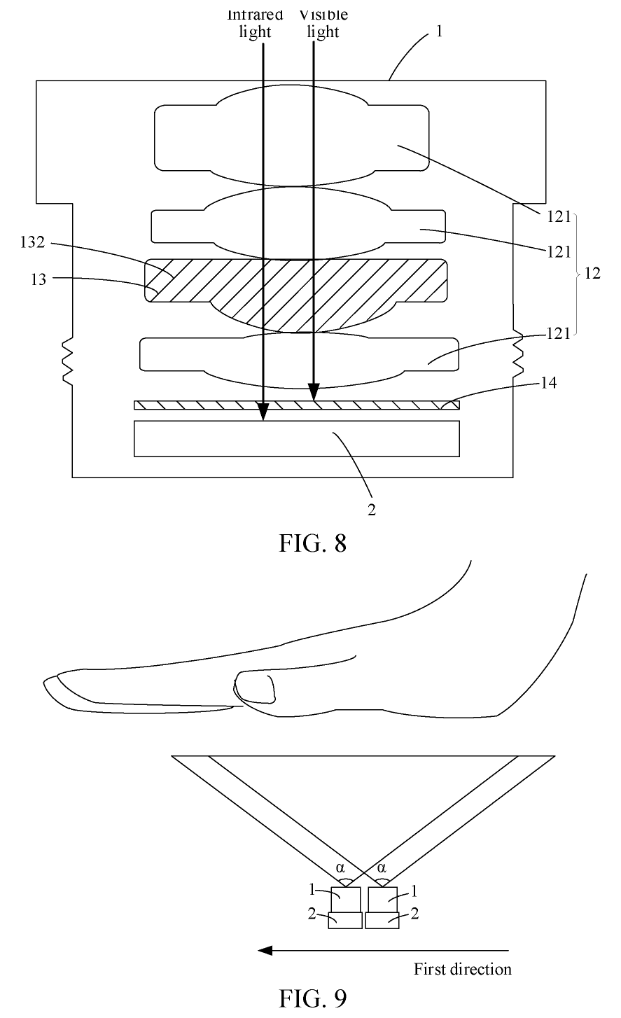

In some examples, the lens assembly 1 is an infrared-light lens assembly 1b. As shown in FIG. 8, the lens assembly 1 further includes an infrared filter 14, the infrared filter 14 is located on an object side of the image sensor 2, and the infrared filter 14 is configured to transmit infrared light and filter visible light. For example, the infrared filter is configured to allow infrared light transmission and reject visible light.

Correspondingly, the image sensor 2 is an infrared image sensor. In this way, when a surrounding environment is relatively dark, the lens assembly 1 can photograph an infrared image of the palm, which is conducive to the palm-scan recognition device obtaining a palm feature in the relatively dark environment.

In some examples, when the lens assembly 1 is a visible-light lens assembly 1a, the lens assembly 1 may alternatively have a filter configured to filter the infrared light and transmit the visible light.

In some examples, as shown in FIG. 9, the camera apparatus for a palm-scan recognition device includes two lens modules 1. One lens assembly 1 is the visible-light lens assembly 1a, configured to transmit the visible light, and another lens assembly 1 is the infrared-light lens assembly 1b, configured to transmit the infrared light. Correspondingly, the camera apparatus for a palm-scan recognition device includes two image sensors 2. One image sensor 2 is a color image sensor, opposite to the visible-light lens assembly 1a, and is configured to receive the visible light transmitted by the visible-light lens assembly 1a, to form a color image. Another image sensor 2 is the infrared image sensor, opposite to the infrared-light lens assembly 1b, and is configured to receive the infrared light transmitted by the infrared-light lens assembly 1b, to form a black-and-white image. When the two lens modules 1 are used simultaneously, more palm features can be photographed, which is conducive to the palm-scan recognition device quickly recognizing the user identity.

Types, quantities, and arrangements of lenses of the visible-light lens assembly 1a and the infrared-light lens assembly 1b may be the same or different.

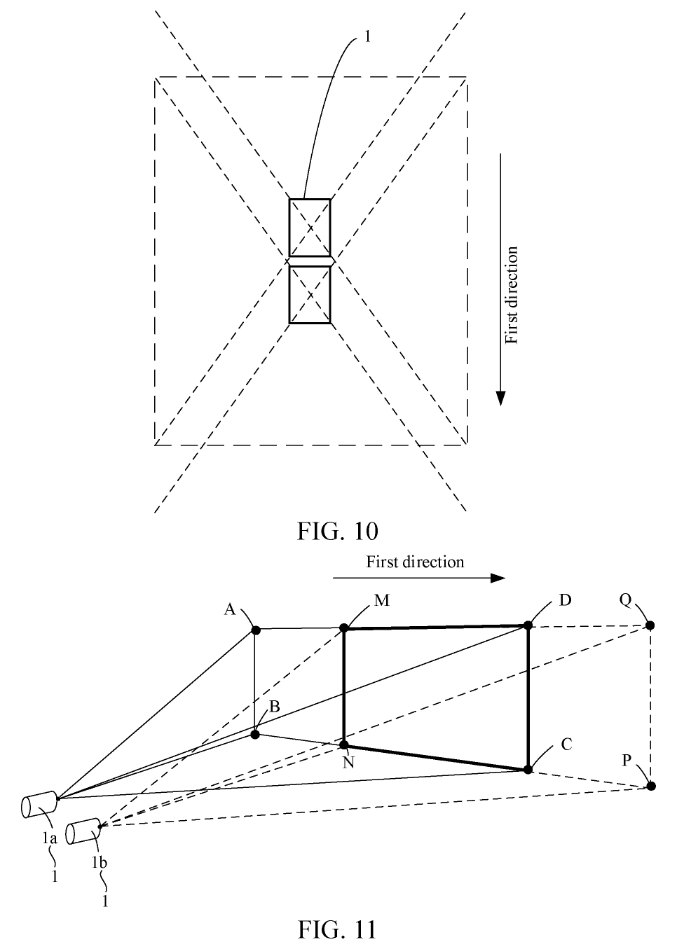

In some examples, as shown in FIG. 9 to FIG. 12, two lens modules 1 are arranged in a first direction shown in the accompanying drawings. An aspect ratio of an overlapping area of fields of view of the infrared-light lens assembly 1b and the visible-light lens assembly 1a is an aspect ratio of a finally obtained palm image. The two lens modules 1 are arranged in the above manner, so that the aspect ratio of the palm image can be 4:3. In this way, an image obtained by the camera apparatus for a palm-scan recognition device can be closer to a proportion of the palm. When the palm is close, obtaining the complete palm image is easier.

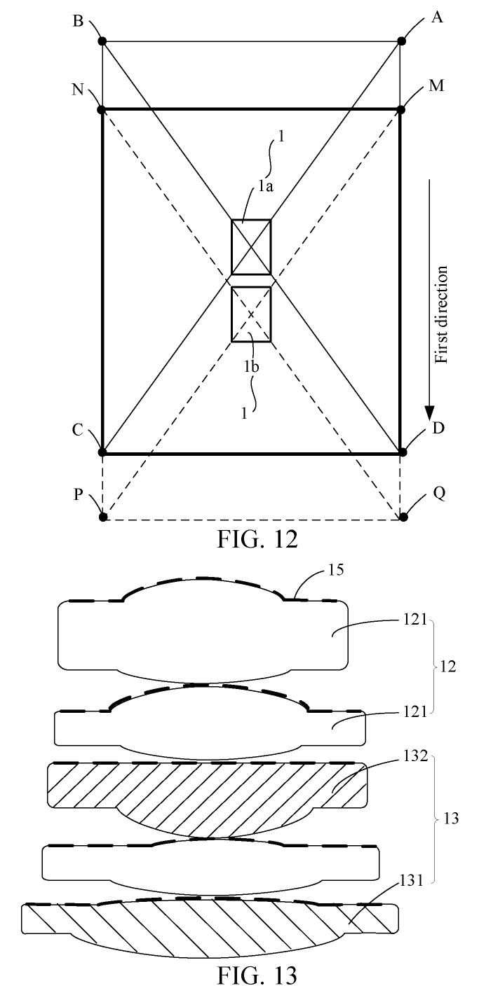

For the palm-scan recognition device lens assembly including the visible-light lens assembly 1a and the infrared-light lens assembly 1b, a field of view area of the camera apparatus for a palm-scan recognition device is the overlapping area of field of view areas of the visible-light lens assembly 1a and the infrared-light lens assembly 1b. For example, as shown in FIG. 11 and FIG. 12, the field of view area of the visible-light lens assembly 1a is a rectangular area ABCD, and the field of view area of the infrared-light lens assembly 1b is a rectangular area MNPQ. Therefore, the field of view area of the camera apparatus for a palm-scan recognition device is an overlapping area of the rectangular area ABCD and the rectangular area MNPQ, that is, a rectangular area MNCD.

Through an experiment, when an aspect ratio (or referred to as a length-to-width ratio) of the rectangular area MNCD is 4:3, image quality obtained by the camera apparatus for a palm-scan recognition device is higher. Therefore, the aspect ratio of the rectangular area MNCD may be set to 4:3. However, an aspect ratio of the field of view area of the visible-light lens assembly 1a to the field of view area of the infrared-light lens assembly 1b provided in this embodiment of the present disclosure is generally X:3, that is, BC:AB = X:3, and NP:MN = X:3, where X is greater than 4, for example, 5. Therefore, if an overlapping area with the aspect ratio being 4:3 is to be obtained, the rectangular area ABCD and the rectangular area MNPQ need to be arranged in a length direction of the rectangular area ABCD (or the rectangular area MNPQ), where the length direction is the first direction. In this way, compared with the rectangular area ABCD (or the rectangular area MNPQ), a length of the overlapping rectangular area MNCD is reduced and a width of the overlapping rectangular area MNCD remains unchanged, so that the aspect ratio of the rectangular area MNCD can reach 4:3.

Certainly, in some other examples, the two lens modules 1 may alternatively be arranged in another manner according to a practical requirement. This is not specifically limited in this embodiment of the present disclosure.

In some examples, as shown in FIG. 13, surfaces of the first set of lenses 12 and the second set of lenses 13 have anti-reflection films 15. The anti-reflection film 15 is configured to increase refractiveness of the lens assembly 1 and reduce reflection, and suppress the glare of the lens assembly 1 to increase a transmittance rate. In this way, the camera apparatus for a palm-scan recognition device is more likely to obtain a clearer image. Each lens of the first set of lenses 12 and each lens of the second set of lenses 13 are plated with the antireflective film 15. A material of the anti-reflection film 15 may be magnesium fluoride, titanium oxide, lead sulfide, lead selenide, or the like. A thickness of the anti-reflection film 15 may range from 300 nm to 500 nm. A curvature of the anti-reflection film 15 is the same as a curvature of a lens to which the anti-reflection film 15 is bonded.

According to one or more embodiments, a camera apparatus for a palm-scan recognition device may include a first lens assembly and a first image sensor at an image side of the first lens assembly. In some examples, the first lens assembly may include a lens barrel, a first set of lenses configured to converge light from an object side of the first lens assembly, and a second set of lenses configured to adjust a field of view and distortion of the first lens assembly observable at an image side of the first lens assembly. In some examples, the first set of lenses includes one or more of a plastic lens or a spherical glass lens, and the second set of lenses includes one or more of a freeform lens or a molded glass lens. In some examples, the first set of lenses and the second set of lenses are inside the lens barrel.

In some embodiments, the camera apparatus may further include a second lens assembly and a second image sensor at an image side of the second lens assembly. In some examples, the first image sensor is configured to capture a visible-light spectrum, and the second image sensor is configured to capture an infrared-light spectrum. In some examples, the second lens assembly includes an infrared filter at an object side of the second image sensor, the infrared filter being configured to pass through infrared light transmission and reject visible light.

An embodiment of the present disclosure further provides a palm-scan recognition device. The palm-scan recognition device includes the foregoing camera apparatus for a palm-scan recognition device.

Examples of the reference numbers in drawings include:

1. Lens assembly, 11. lens barrel, 12. first set of lenses, 121. plastic lens, 122. spherical glass lens, 13. second set of lenses, 131. freeform lens, 132. molded glass lens, 14. infrared filter film, 15, anti-reflection film, 1a. visible-light lens assembly, and 1b. infrared-light lens assembly; and

2. image sensor.

The foregoing descriptions are merely non-limiting examples of the present disclosure and are not intended to limit the present disclosure. Any modification, equivalent replacement, or improvement made is to fall within the scope of the present disclosure.

What is claimed is:

1. A camera apparatus for a palm-scan recognition device, comprising:
a first lens assembly, including:
a lens barrel;
a first set of lenses configured to converge light from an object side of the first lens assembly; and
a second set of lenses configured to adjust a field of view and distortion of the first lens assembly observable at an image side of the first lens assembly; and
a first image sensor at an image side of the first lens assembly, wherein
the first set of lenses includes one or more of a plastic lens or a spherical glass lens,
the second set of lenses includes one or more of a freeform lens or a molded glass lens, and
the first set of lenses and the second set of lenses are inside the lens barrel.

2. The camera apparatus according to claim 1, wherein
the second set of lenses includes the freeform lens that is closest to the first image sensor among the second set of lenses.

3. The camera apparatus according to claim 1, wherein the second set of lenses includes the molded glass lens that is between two lenses of the first set of lenses.

4. The camera apparatus according to claim 3, wherein
the first set of lenses includes three plastic lenses,
two of the three plastic lenses are on an object side of the molded glass lens, and
one of the three plastic lenses is on an image side of the molded glass lens.

5. The camera apparatus according to claim 1, wherein
the first set of lenses includes two plastic lenses and one spherical glass lens, and
the two plastic lenses, the molded glass lens, the spherical glass lens, the freeform lens, and the first image sensor are arranged sequentially along an axial direction of the lens barrel.

6. The camera apparatus according to claim 1, wherein a degree of freedom of the freeform lens ranges from 30 to 80.

7. The camera apparatus according to claim 1, wherein a degree of freedom of the molded glass lens ranges from 10 to 30.

8. The camera apparatus according to claim 1, wherein an inner wall of the lens barrel has an anti-glare coating.

9. The camera apparatus according to claim 1, further comprising:
a second lens assembly; and
a second image sensor at an image side of the second lens assembly, wherein
the first image sensor is configured to capture a visible-light spectrum,
the second image sensor is configured to capture an infrared-light spectrum, and
the second lens assembly includes an infrared filter at an object side of the second image sensor, the infrared filter being configured to pass through infrared light transmission and reject visible light.

10. The camera apparatus according to claim 9, wherein an aspect ratio of an overlap between the adjusted field of view of the first lens assembly and an adjusted field of view of the second lens assembly is N:3, N being greater than or equal to 4.

11. A palm-scan recognition device, comprising:
a first lens assembly, including:
a lens barrel;
a first set of lenses configured to converge light from an object side of the first lens assembly; and
a second set of lenses configured to adjust a field of view and distortion of the first lens assembly observable at an image side of the first lens assembly; and
a first image sensor at an image side of the first lens assembly,
wherein
the first set of lenses includes one or more of a plastic lens or a spherical glass lens,
the second set of lenses includes one or more of a freeform lens or a molded glass lens, and
the first set of lenses and the second set of lenses are inside the lens barrel.

12. The palm-scan recognition device according to claim 11, wherein
the second set of lenses includes the freeform lens that is closest to the first image sensor among the second set of lenses.

13. The palm-scan recognition device according to claim 11, wherein the second set of lenses includes the molded glass lens that is between two lenses of the first set of lenses.

14. The palm-scan recognition device according to claim 13, wherein
the first set of lenses includes three plastic lenses,
two of the three plastic lenses are on an object side of the molded glass lens, and
one of the three plastic lenses is on an image side of the molded glass lens.

15. The palm-scan recognition device according to claim 11, wherein
the first set of lenses includes two plastic lenses and one spherical glass lens, and
the two plastic lenses, the molded glass lens, the spherical glass lens, the freeform lens, and the first image sensor are arranged along an axial direction of the lens barrel in an order recited.

16. The palm-scan recognition device according to claim 11, wherein a degree of freedom of the freeform lens ranges from 30 to 80.

17. The palm-scan recognition device according to claim 11, wherein a degree of freedom of the molded glass lens ranges from 10 to 30.

18. The palm-scan recognition device according to claim 11, wherein an inner wall of the lens barrel has an anti-glare coating.

19. The palm-scan recognition device according to claim 11, further comprising:
a second lens assembly; and
a second image sensor at an image side of the second lens assembly,
wherein
the first lens assembly and the first image sensor are configured for an operation based on a visible-light spectrum,
the second lens assembly and the second image sensor are configured for an operation based on an infrared-light spectrum, and
the second lens assembly includes an infrared filter at an object side of the second image sensor, the infrared filter being configured to allow infrared light transmission and reject visible light.

20. The palm-scan recognition device according to claim 19, wherein an aspect ratio of an overlap between the adjusted field of view of the first lens assembly and an adjusted field of view of the second lens assembly is N:3, N being greater than or equal to 4.
